(19) United States
(12) Patent Application Publication
(10) Pub. No.: US 2025/0319477 A1
(43) Pub. Date: Oct. 16, 2025

(54) APPARATUS FOR ELECTROSTATIC DEACTIVATION AND REMOVAL OF HAZARDOUS AEROSOLS FROM AIR

(71) Applicant: Brainmate GmbH, Munich (DE)

(72) Inventors: Helmut FLUHRER, Luzern (CH); Elena DAVYDOVA, Luzern (CH); Yuri SAVELIEV, Egmating (DE)

(21) Appl. No.: 18/269,348

(22) PCT Filed: Dec. 23, 2021
(86) PCT No.: PCT/EP2021/087550

§ 371 Date: Jun. 23, 2023

(30) Foreign Application Priority Data
Dec. 30, 2020 (EP) 20217901.6

(51) Int. Cl. B03C 3/16; B03C 3/36; B03C 3/41; B03C 3/68; B03C 3/88

(52) U.S. Cl. CPC B03C 3/16; B03C 3/368; B03C 3/41; B03C 3/68; B03C 3/88; B03C 2201/08; B03C 2201/10

(57) ABSTRACT

It is disclosed an apparatus for electrostatic deactivation and removal of hazardous aerosols from air, said apparatus comprising an ionization zone (2) for charging aerosols contained in a stream of supplied air and for obtaining aerosols having negative air ions, a spraying zone (4) for generating positively charged droplets and for absorbing said charged aerosols by contacting them with said generated positively charged droplets, and a collection device for collecting said negative air ions and said absorbed aerosols from said spraying zone (4).

### FIELD OF THE INVENTION

The present invention relates to an apparatus for electrostatic deactivation and removal of hazardous aerosols from air, specifically for air cleaning and/or purification and disinfection by combining air ionization and electro-spraying. Hazardous aerosols include conventional biological agents and genetically engineered organisms as an example.

### PRIOR ART

Aerosol removal from air has become an important aspect in times of bacteria or virus pandemics. There are many applications for the removal of pathogenic bio-aerosols recently discovered to be a primary source and reason of Covid-19 pandemic. There is a concern that the humanity may face pandemics of other airborne transmitted pathogens in the future. Another concern are all types of bioweapons developed and used by unfriendly government or terrorists.

Many viruses including SARS-CoV-2 (Covid-19) are small in size (60-125 nm). Most of them are released to the air by infected humans and possibly by other sources and are in the form of droplets in a wide spectrum of sizes. Large droplets are sedimented within a short distance from an infected person, but smaller ones evaporate quickly and evaporation residues that contain viruses may stay in the air for hours. In particular, this is especially a problem in enclosed premises with limited ventilation and recirculated air. At the moment, there is no reliable data on the size spectrum of human-produced evaporation residues. However, it is known that only some special air filters (e.g. so-called N95 technology) are able to catch particles with sizes starting from about 300 nm and may provide a reasonable degree of protection. Although those filters are widely used in face masks, their application for purifying large volumes of air is highly cumbersome. High costs of sub-micron particle filters are prohibitive in large applications; the filters should be regularly changed and/or replaced which is a dangerous procedure because of a high risk of dissemination of the collected microbes. Their pre-treatment with UV light has been proposed but this brings about an extra degree of complexity and extra costs. Moreover, air filters introduce a high pressure drop at high air flows inevitable in large applications, resulting in a high energy consumption.

It was reported in a number of publications that many microbial species were partly de-activated by negative air ions with different de-activation fractions for different species. Air ions are small molecular clusters with the sizes of about few nanometers and 1-2 electronic charges. Although dielectric barrier discharge (DBD) systems have also been proposed for this purpose (e.g. Xia et al., 2019), the common way to produce air ions of a certain electric sign is by direct current (DC) corona discharge from an emitter electrode, which is in general an electrically conductive object with one or more sharp features (i.e. a part with a low radius of curvature) such as one or more electrically coupled needles or thin wires. The emitter electrode of corona discharge is electrically coupled to the active electrode of a high-voltage direct current (HVDC) source, the second electrode of which is grounded. The produced air ions with the sign of the active electrode of HVDC are repulsed and drift from the emitter electrode, attaching to and thus electrically charging aerosol particles in the air, in particular bio-aerosols. The mechanism and probably multiple mechanisms of the de-activation of micro-organisms by air ion attachment are not fully understood yet.

As for SARS-CoV-2 in particular, the de-activation efficiency of this pathogen by air ionization in terms of survival rate at given conditions has not been studied yet. However, it is understood that the air disinfection by ionization is not a reliable solution per se. Alternatively or additionally, the physical removal of pathogens from the air could be a more viable solution. Moreover, it is believed that under some conditions the direct inhalation of ionized air could be dangerous for health. The first problem is that negative corona discharge produces ozone and nitrogen oxides which are poisonous gases. Therefore, a particular corona discharge device should be properly designed to make sure that concentrations of those gases do not exceed the limits imposed by safety regulations. Health benefits of negative ions were reported in a number of publications. However, in some cases, including the case of microbial air contamination under consideration, air ionization of either electric sign may bring another problem, which is the attachment of aerosols including microbes, allergens and other harmful particles to the surfaces of respiratory tract and to the lungs in particular, is enhanced by particle electrification. This is due to the attractive electric force between a charged aerosol particle and its image charge produced on an organ. This effect may be significant even for nano-particles carrying only several electronic charges (e.g. Cohen et al., 1996; Fews et al., 1999). Because the de-activation of pathogenic aerosols by air ions is only partial, the deposition of the remaining active pathogens in the respiratory tract may be higher than in the absence of air ionization. Therefore, for the sake of safety with uncertain total effect of the de-activation and deposition, charged aerosols should be removed from the air before it enters the respiratory tract. Electrostatic precipitators (ESPs) that typically comprise an emitter electrode of corona discharge and electrodes on which charged aerosol particles are collected by attractive electric sources have been proposed for this purpose.

ESPs have been used for the removal of relatively large bio-aerosols such as pollen, fungi and some bacteria (e.g. Alonso et al., 2016). Some viruses have relatively large sizes such as filamentous virions. Influenza A is one of such virions, which has elongated shape with the diameter 80-100 nm and variable length of several um. Hagbom et al. (2015) successfully de-activated (>97%) and collected (up to 21%) influenza A by a small ESP after 40 min. in a small chamber (19 m3), which prevented 100% (4/4) of guinea pigs from infection. However, ESPs are not effective for nano-particles at high process air flows (i.e. the volume of air passed per unit time). Because of the direct relationship between aerosol particle size and the maximum electric charge that it can achieve, de-activation and collection of smaller particles may be problematic. For example, 100 nm particles can achieve about 5-10 electronic charges as reported in different literature (e.g. Marquard, 2007). Sufficient charging of nano-particles for this purpose is possible only in the presence of sufficiently strong electric field, the case called field charging. This takes place only at very short distances from the emitter electrode of corona discharge and may take some time of up to about 2 seconds to fully charge nano-particles. Limited volume of charging zone and relatively long charging time make ESPs impractical with high process air flows. In practice, the use of ESPs for small particles is limited to air sampling devices. Safe cleaning of ESP collector electrodes from the aggregated contagious microbes is another technical challenge.

Another approach to the problem of aerosol removal from air is based on their scavenging by a large surface of a body of water or other liquid with a high surface-to-volume ratio, the method called wet scrubbing. Air motions, especially turbulent, and the Brownian motions of aerosol particles significantly promote this process. In wet scrubbing, biologically hazardous aerosols are handled in liquid suspension, which is easier and safer than in the dry form. They can be de-activated in liquid by many means such as heating, using disinfectors, dissolving ozone, exposing to strong corona discharge etc. In many cases, after sedimentation or flocculation of the collected particles, the working liquid can be re-used. Alternatively, the working liquid is replaced and its recycling can be done externally.

There are three main types of wet scrubbers that have been reported in the literature, ie falling film, packed bed or porous pad and spray tower. In falling film towers, the liquid flows in the form of thin films over the solid surfaces, and the process air (i.e. air that is passing through the system, typically with the aid of fans) comes in direct contact with these thin liquid films. The solid surfaces can be tubes or plates, generally arranged in vertical direction. High construction costs and bulky size are the main drawbacks of these towers. In the packed bed towers or porous pads, the process air comes in direct contact with the liquid on large surface of the packing or pad wetted by the liquid flowing downwards. Compared to falling film towers, much higher surface-to-volume values can be achieved in compact systems at much lower capital costs. The main disadvantage of packed bed towers and porous pads is a high pressure drop of process air, especially at high process air flows. In particular, this may lead to high capital and power consumption costs by fans. Another disadvantage of such systems is the maintenance that may be required to clean or replace beddings or pads due to the clogging by scavenged aerosols that are not completely removed by liquid flow and can be accumulated over the time.

In spray towers, air and liquid interact on the surface of small liquid droplets that are typically produced by spray nozzles. In typical spray tower designs, the process air flows upwards, and the liquid droplets from one or more spray nozzles close to the top of the tower, sediment to the bottom. Compared to other abovementioned types of wet scrubbers, practically negligible air pressure drop at very high achievable values of surface-to-volume ratio, low capital and operational costs are main advantages of spray towers. Those advantages make spray towers more suitable in larger applications where higher process air flows should be treated. Smaller droplets have a higher aerosol removal efficiency, but their production requires higher hydraulic liquid pressure and smaller orifices of nozzles, which are more prone to the blockage by solid particles that may be suspended in the liquid. Therefore, the liquid should be well filtered, sedimented or flocculated, especially if re-used as mentioned above. Moreover, smaller droplet sizes should be carefully balanced with lower velocities of process air to allow droplet sedimentation.

The main disadvantage associated with spray towers is that some droplets, especially the smallest ones from the droplet size spectrum, may exit the system due to their carryover by process air. In order to minimize the carryover, severe limitations on droplet size spectrum and the process air flow should be imposed. For any type of spray nozzle, the droplet size spectrum is poly-dispersed. Moreover, smaller water droplets may evaporate, and their evaporation residues can even easier escape with process air. Due to those factors, scaling up of spray towers for high process air flows can be problematic. To combat the problem of droplet carryover, Kumar et al. (2011) proposed mesh packings of spray towers. A significant improvement of performance, which authors claimed as “zero carryover” have been achieved. However, at higher air flows, the inhibition of droplet carryover may come at the cost of the increased pressure drop.

A simple and efficient approach to produce droplets is electro-spraying which is based on liquid atomization by electrical forces. The electro-spraying nozzle is usually made in the form of a capillary where the liquid exiting it is exposed to a strong electric field. For water and other electrically conductive liquids, this is typically achieved with a high-voltage charging electrode placed in the vicinity of and acting on the electrically grounded liquid, wherein the electric sign of charged droplets is opposite to the polarity of this electrode. The shear stress on the liquid surface, due to the established electric field, causes the elongation of liquid jet and its disintegration into droplets. The produced droplets can be electrified by this inductive charging to a degree when electrostatic forces overcome the surface tension, causing the fragmentation of droplets into smaller ones. This process, known as Rayleigh instability (Rayleigh, 1882), may repeat many times and the droplets produced by electro-spraying can be extremely small, with sizes about 1 μm and even smaller in some cases. Another advantage of the electro-spraying is that droplets are highly charged, up to a fraction of the Rayleigh instability limit.

The charge and size of the droplets can be controlled to some extent by adjusting the liquid flow rate and the voltage applied to the nozzle electrode. Charged droplets are self-dispersing in the space due to mutual Coulomb repulsion, which results in the inhibition of droplet agglomeration by coalescence, which is a common problem with conventional spraying nozzles. In commercial electro-spraying nozzles, depending on a particular design and operating voltage, droplets with the diameter ranging between 10 μm and 100 μm can be easily produced at a low water pressure, nozzle orifice of 0.5-1 mm, and the electrode consumption current of several micro amperes per nozzle.

Electric charges on droplets and/or aerosol particles my significantly enhance aerosol scavenging by attractive electric forces. This process called electro-scavenging in some literature, plays an important role in cloud microphysics by promoting ice production in super-cooled clouds (i.e. those at temperatures below 0° C.), which affects weather and climate patterns (e.g. Tinsley et al., 2000; Jaworek et al., 2002). Contact ice nucleation may occur when a solid aerosol particle is scavenged by the descending super-cooled droplet, which may statistically lead to the freezing of the latter. The effect of attractive electric forces on trajectories of aerosol particles near a descending droplet is shown in FIG. 1.

Uncharged aerosol particles flow around the droplet (FIG. 1a). This is especially problematic for smaller particles in conventional spray towers. In the presence of attractive electric forces, particles cross air streamlines (FIG. 1b), which enhances aerosol scavenging.

Tepper at al. (2007) proposed experimental design of spray electro-scrubber where aerosol particles were scavenged by electro-spraying droplets due to the charge-to-dipole attractive force between a charged droplet and aerosol particle polarized in the electric field of the neighboring droplet (Jaworek et al., 2002). Then the droplets evaporated leading to the formation of solid residues, which are aggregates of scavenged aerosols retaining a significant electric charge. Those residues can be effectively removed by an ESP, thus solving the problem of droplet carryover at nearly zero pressure drop.

Although the total aerosol removal efficiency of spray electro-scrubber proposed by Tepper at al. (2007) is high, removal efficiencies of aerosol particles with different sizes are different because the droplet-induced dipole moment of a particle and thus the attractive force are proportional to the particle size. Therefore, electro-scavenging of uncharged nano-particles is less effective and thus their removal efficiency is lower compared to that of larger particles. However, introducing even as small as several electronic charges to aerosol particles of the opposite to droplet's sign can significantly enhance the electro-scavenging due to additional long-range Coulomb attractive force (e.g. Jaworek et al., 2002). As previously mentioned, virus-size particles can achieve only about several electronic charges. However, due to high electric charges on electro-spraying droplets, relatively high values of the resulting Coulomb force can solve and the problem of nano-particle electro-scavenging. It is preferable that the polarity of DC corona discharge for aerosol charging is negative, so the droplet electric sign is positive. One of the reasons is that negative ions are more efficient in de-activation of some fraction of microbial bio-aerosols at this stage. Another reason for this will be discussed later.

However, the introduction of aerosols charged by air ionization to process air laden with electro-spraying droplets of the opposite sign has several technical problems. The first problem is that only a small fraction of air ions produced by corona discharge is attached to aerosols in typical air conditions. Compared to charged aerosols, air ions have a high electrical mobility and their motion may be highly influenced by electric field. Therefore, those of the opposite sign will quickly attach to highly charged droplets resulting in almost instant charge loss of the latter before aerosols can reach droplets. Therefore, air ion concentration in the process air should be minimized as much as possible before the interaction with charged droplets. In principle, it can be achieved with an air ion collector electrode while the motion of charged aerosols with low electrical mobility is mostly directed by process air.

Other problems are related to droplet evaporation. A highly charged droplet will keep most of the original charge during its evaporation only up to a certain point, at which the electric field strength at the droplet surface will exceed the electrical breakdown threshold of the air (in case of typical electro-spraying droplet sizes, this is the Paschen limit). This will initiate corona discharge leading to the droplet charge loss and the production of air ions of the droplet sign. This process will continue until the droplet evaporates. In addition to the droplet charge loss, air ions of droplet sign may case a rapid loss of the opposite sign charge on nano-particle aerosols. Another issue is that the vapor density gradient around evaporating droplet is negative and the diffusophoretic force on aerosol particle is positive (away from the droplet), which will further inhibit aerosol scavenging, especially of small particles. Moreover, air ions and gases produced by corona discharge of evaporating charged droplets may be hazardous to the health as mentioned above. In the recommended case of positively charged droplets, positive ions especially problematic because their physiological effects on human and animals are detrimental (even if in sterile air) which was reported in the literature. Another problem with droplet evaporation is that it may cause a noticeable increase in the humidity of indoor air. Although Tepper at al. (2007) argued that this increase is not significant, this may not be true in many cases. Another good reason for the evaporation inhibition and collection of droplets rather than their evaporation residues is handling pathogens as liquid suspension is preferred as mentioned previously.

The object of the invention is to provide an improved apparatus for electrostatic deactivation and removal of hazardous aerosols from air without a technical-economic limitation for the scaling up the system extensively, wherein the apparatus proves to be efficient for absorbing contaminated aerosols, such as aerosols containing virus or bacteria loads.

### SUMMARY OF THE INVENTION

The object of the invention is achieved by an apparatus for electrostatic deactivation and removal of hazardous aerosols from air, said apparatus comprising an ionization zone for charging aerosols contained in a stream of supplied air and for obtaining aerosols having negative air ions, a spraying zone for generating positively charged droplets and for absorbing said charged aerosols by contacting them with said generated positively charged droplets, and a collection device for collecting said negative air ions and said absorbed aerosols from said spraying zone.

The advantage of the apparatus for electrostatic deactivation and removal of hazardous aerosols from air is that air can be cleaned and disinfected effectively by combining air ionization and electro-spraying. Even pathogenic aerosols with small sizes like viruses have can be absorbed and deactivated.

It is preferred that said ionization zone comprises at least one emitter electrode of corona discharge.

It is preferred that said ionization zone further comprises at least one air inlet for guiding said stream of supplied air past said emitter electrode of corona discharge.

It is preferred that said ionization zone further comprises at least one high-voltage direct current source having negative polarity, which is connected to said emitter electrode of corona discharge.

It is preferred that said aerosols are charged in said ionization zone in a time period of less than 1 sec in air flow volumes ranging between starting from 50 to about 300 m³/h or higher, preferably between 100 and 300 m³/h, more preferably between 150 and 300 m³/h.

It is preferred that said spraying zone further comprises at least one electro-spraying electrode for ejecting droplets in at least one direction across said stream of supplied air. The advantage of droplets ejection across the stream of supplied air is that the apparatus cannot harm any person during operation with high-voltage.

It is preferred that said spraying zone further comprises at least one air outlet.

It is preferred that said spraying zone comprises at least one high-voltage direct current source having positive polarity, which is connected to said electro-spraying electrode. The spraying distance, which is the distance from the liquid ejection point to the point at which the produced continuous liquid jet disintegrates into droplet spray, with directly electrified liquid by attaching the high-voltage direct current source having positive polarity directly to the at least one electro-spraying electrode is much smaller than when the produced continuous liquid jet is electrified.

It is preferred that said collection device comprises at least one grounded droplet collector in the form of two opposed walls or a surrounding cylinder.

During operation with high-voltage, this apparatus cannot harm any person due to the immediate collecting of the sprayed droplets with the grounded droplet collector.

It is preferred that said collection device further comprises an ion collector electrode which is disposed between said ionization zone and said spraying zone.

It is preferred that said air inlet includes at least one suction fan and/or said air outlet includes at least one exhaust fan.

The advantage of the use of fans is that air pressure can be controlled and no access to apparatus and therefore no misuse is possible.

It is preferred that said grounded droplet collector has a hydrophilic surface.

It is preferred that said grounded droplet collector extends over spraying zone and ionization zone.

The advantage of the abovementioned feature is that the liquid, which is running down the grounded droplet collector, cleans the grounded droplet collector at the same time.

It is preferred that said electro-spraying electrode has a shape of a perforated pipe, which is arranged parallel to said grounded droplet collector.

Such shape is advantageous for maximizing the uniformity of spray droplets distribution in process air.

It is preferred that the apparatus further comprises at least one liquid regeneration system, comprising a first pump for pumping said absorbed aerosols to at least one collection tank, a second pump for pumping liquid from said collection tank through a first valve to at least one sedimentation tank, a third pump for pumping liquid from said sedimentation tank through a second valve to at least one storage tank, a fourth pump for pumping liquid from said storage tank to said electro-spraying electrode, a fifth pump for pumping liquid from at least one liquid reservoir through a third valve to said sedimentation tank, and a sixth pump for pumping out sediments from said sedimentation tank through a fourth valve.

This setup of the liquid regeneration system operates in a specific sequence for separation of high-voltage circuit to achieve operational safety.

It is preferred that said spraying zone further comprises at least one collector electrode located in air flow direction in front of said air outlet.

Abovementioned collector electrode is a backup for collecting charged aerosols from the stream of supplied air.

It is preferred that the apparatus further comprises at least one gutter for collecting said ejected droplets, collected by said grounded droplet collector.

It is preferred that the apparatus further comprises at least one stand for supporting said apparatus.

The invention is now illustrated by non-limiting examples in connection with the drawings.

### BRIEF DESCRIPTION OF THE DRAWING

Examples are described with reference to the following drawing, wherein

FIG. 1 shows a schematic drawing of the apparatus for electrostatic deactivation and removal of hazardous aerosols from air in accordance with the invention.

### DETAILED DESCRIPTION OF THE DRAWING

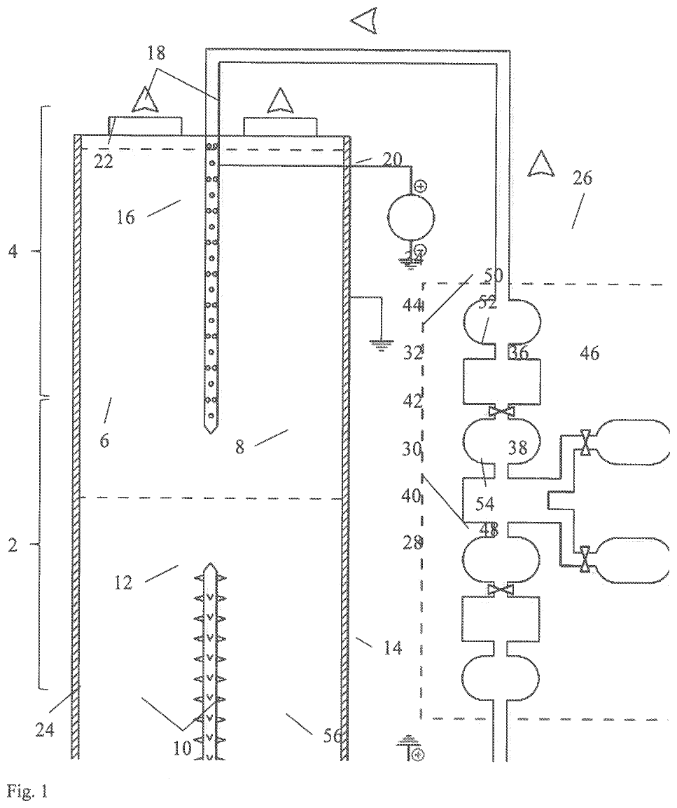

In FIG. 1, a schematic drawing of the apparatus for electrostatic deactivation and removal of hazardous aerosols from air in accordance with the invention is shown.

The build-up shows ionization zone 2, which is arranged in the lower left portion of the apparatus, spraying zone 4, which is arranged above the ionization zone 2 and liquid regeneration system 26, which is arranged on the right side of both zones.

Ionization zone 2 is positioned on a stand 56 and comprises emitter electrode of corona discharge 12, which is connected to high-voltage direct current source having negative polarity 14 and extends upwards from the bottom. Further, gutter 24 is arranged at the bottom of this zone.

Spraying zone 4 comprises electro-spraying electrode 16, which is connected to high-voltage direct current source having positive polarity 20 and extends downwards from the top, and collector electrode 22, which is arranged in the upper region of this zone. Between ionization zone 2 and spraying zone 4, an ion collector electrode 6 is arranged and covers the whole air flow cross-section.

A cylindrical grounded droplet collector 8 accommodates ionization zone 2 and spraying zone 4.

Further, air inlet 10 is arranged at the bottom of ionization zone 2 and air outlet 18 is arranged at the top of spraying zone 4.

The liquid regeneration system 26 connects gutter 24 with electro-spraying electrode 16 via pipes or hoses. A first pump 28 pumps liquid from gutter 24 to collection tank 40, a second pump 30 pumps liquid from collection tank 40 through a first valve 48 to sedimentation tank 42, a third pump 32 pumps liquid from sedimentation tank 42 through a second valve 50 to storage tank 44 and a fourth pump 34 pumps liquid from storage tank 44 to electro-spraying electrode 16.

The working liquid is preferably an aqueous solution of a salt at relatively high concentrations affecting the equilibrium relative humidity (ERH), in which microbes are de-activated after a certain time. Additionally, salt solution deactivates pathogens and suppresses evaporation of water. The working liquid is pumped by fifth pump 36 to the sedimentation tank 42 from liquid reservoir 46 through third valve 52. The liquid from the sedimentation tank 42 is taken for recycling off-site through a sediment outlet, wherein a sixth pump 38 pumps out sediments from sedimentation tank 42 through a fourth valve 54.

The specific sequence during operation of the liquid regeneration system for separation of high-voltage circuit to achieve operational safety is:
A) Initial conditions: high-voltage direct current source having positive polarity and high-voltage direct current source having negative polarity are off, all valves are closed, and all pumps are off.
B) Third valve is open and then fifth pump is on in order to fill in the sedimentation tank. After the completion of this procedure, fifth pump is off and then third valve is closed.
C) Second valve is open and then third pump is on in order to transport the liquid from the sedimentation tank into the storage tank. After the completion of this procedure, third pump is off and then second valve is closed.
D) Suction and exhaust fans are on, high-voltage direct current source having positive polarity and high-voltage direct current source having negative polarity are on, and then fourth pump and first pump are on. This is the start of operation. The storage tank and fourth pump are subject to high-voltage direct current source having positive polarity high-voltage since then.
E) Shortly before the storage tank is due to be re-filled, the following procedures apply:
   a. Second valve is opened and then third pump is on in order to transport the cleaned liquid from the sedimentation tank into the storage tank. At this stage the sedimentation tank and second pump and third pump are the parts of high-voltage circuit of high-voltage direct current source having positive polarity. After the completion of this procedure, third pump 3 is off and then second valve is closed, therefore ending the temporary belonging of the sedimentation tank to the high-voltage circuit of high-voltage direct current source having positive polarity while being isolated from any part of the grounded liquid circuit with the aid of still closed first pump.
   b. Fourth valve is opened and then sixth pump is on in order to transport the remaining muddy liquid contaminated sediment from the sedimentation tank out of the liquid regeneration system. After the completion of this procedure, sixth pump is off and then fourth valve is closed.
   c. A shortfall of the liquid in the sedimentation tank due to the partial disposal as described in b. is compensated by the filling up as described in B).
F) First valve is open and then second pump is on in order to transport the liquid from the collection tank into the sedimentation tank. After the completion of this procedure, second pump is off and then first valve is closed.
G) When turning the system off, it is preferable to follow the following order of switching off individual components:
   a. Fourth pump is off
   b. High-voltage direct current source having positive polarity, high-voltage direct current source having negative polarity, and all fans are off
   c. First pump is off

This operational sequence was proposed with special attention on the separation of high-voltage circuit comprising the directly charged liquid from the grounded circuit comprising electrically grounded liquid. To achieve the highest safety level, it is highly recommended that not only pumps, but valve solenoids as well are fed with a traditional DC current source comprising the true transformer and rectifier, unless the safety of an adapter with no transformer, so-called electronic transformer, is proven.

In a first cross-flows configuration (this configuration is not shown in FIG. 1), the wet spraying zone comprises a grounded droplet collector in the shape of a rectangular plate, which is positioned vertically or at a small angle to the direction of gravity, and an electro-spraying electrode, which orifices are at a certain distance from each other and the produced spray jets are normal to the electro-spraying electrode. As a non-limiting example, the electro-spraying electrode may comprise one or more perforated pipes parallel to the plate. Perforation orifices separated by a minimum inter-jet distance and positioned towards the plate are aligned along the pipe, to which first end the pressurized liquid is fed, and the second end is closed. Process air with aerosols charged in the ionization zone with the sign opposite to that of electro-spraying electrode flows between the plate and the electro-spraying electrode. In this configuration, the liquid accumulated on the grounded droplet collector electrode is not charged and can be safely removed without dripping, for example with the aid of one or more gutter(s) immediately attached to the plate edge(s) or similar means, depending on the positioning of the grounded droplet collector electrode relative to the gravity direction. The positioning of the grounded collector electrode and thus the axis of the apparatus embodiment relative to the direction of gravity can be selected based on the ease of liquid run-off, its removal and other considerations, e.g. nearly vertical or horizontal within a small range of angles because the directions of process air and spray flows are practically normal in both cases.

In a second co-axial cross-flows configuration (shown in FIG. 1), where the grounded collector electrode 8 has a shape of hollow cylinder with the length preferrable at least several times greater than its diameter and the electro-spraying electrode 16 has a shape of perforated pipe positioned at the common axis with the cylinder, where the pressurized conductive working liquid at high-voltage, preferably positive, is supplied to the first end of the electro-spraying electrode, which second end is closed, resulting in the formation of multiple spray jets normal to the inner surface of the cylindrical collector electrode. As a non-limiting example, perforation orifices in the said pipe can be provided in a plurality of pairs, wherein orifices of each pair are positioned opposite to each other in the pipe cross-section, and multiple orifice couples along the pipe are separated with a minimum inter-jet distance. In order to maximize the uniformity of spray droplets distribution in process air, the angle between the axes of neighboring couples is an integer fraction of 360° (preferably 90° or 60°) , and this angle is in the same direction for all couples enumerated from a certain end of the pipe. Process air with aerosols previously charged in ionization section with the sign opposite to that of electro-spraying electrode 16 flows through the cylindrical grounded collector electrode 8 and is approximately normal to that of spray jets from orifices. It is preferred that the axis of the system is vertical or at a small angle to the direction of gravity, which is favorable for the run-off of the accumulated liquid from the inner wall of the cylinder which can be safely removed with gutter 24. In this axial configuration, the ionization zone 2 can be seamlessly integrated into the apparatus by simply providing the emitter electrode of corona discharge 12 in the form of thin wire or a wire-like electrode with sharp points, which is stretched along the axis of a segment of the cylindrical grounded collector electrode 8 and electrically coupled to the negative electrode of high-voltage direct current source 14 or pulsing current source. Although the ionization zone 2 can be located either above or below the wet electro-scrubbing zone (i.e. spraying zone 4), the latter arrangement is preferred because the liquid moisture accumulated in the upper spraying zone 4 can continuously descend over all inner wall surface including its section in ionization zone 2. Provided that this surface is sufficiently hydrophilic and rough on a small scale to provide uniform flow of this moisture at least in ionization zone 2, this descending flow can facilitate continuous washing out some of aerosols that are charged and attracted to the surface by electric forces in ionization zone 2.

In order to minimize the concentration of negative ions in the process air entering spraying zone 4, it is preferred that an electrically conductive and grounded electrode of a planar shape, which does not create a significant air pressure drop and parasitic corona discharge such as but not limited to a mesh, a grid of wire-like electrodes in parallel segments, a perforated plane sheet, etc., extending over the cross-section of air flow, hereinafter referred as ion collector electrode 6, is placed between ionization zone 2 and electro-spraying zone 4 in both configuration 1 and configuration 2. In case of configuration 1, ion collector electrode 6 also serves as collector electrode of corona discharge in the ionization zone 2. Another function of the grounded droplet collector 8, i.e. washing out attracted aerosols, can be introduced to ion collector electrode 6. In practice, the implementation of this function may be technically easier in horizontal setup of configuration 1, in which the grounded droplet collector 8 can be in the form of shallow tray which, in order to facilitate the disposal of accumulating working liquid, is positioned nearly orthogonal to the direction of gravity and liquid exiting grounded droplet collector 8 is pumped on top and distributed over the surface of ion collector electrode. Although this function can be introduced in vertical setup of configuration 1 without the said pumping, a non-planar ion collector electrode 6 may be required, which may complicate the design and introduce extra costs of this component.

In both configuration 1 and configuration 2, it is preferred that process air flow is maintained with suction fan(s) and exhaust fan(s). An optional grounded electrode such as a mesh with a low pressure drop or other used as the previously described ion collector electrode, can be arranged just before exhaust fan(s) relative to process air direction to mitigate a small risk of liquid droplet carryover.

The above-described apparatus for electrostatic deactivation and removal of hazardous aerosols from air is a practical electro-spraying possibility for inducing charges on working liquid by spraying the body of electrically conductive working liquid, which is directly charged by coupling to HVDC or high-voltage (HV) pulsing current source, towards a grounded droplet collector. In this general configuration, electrically conductive liquid should be safely managed in a high-voltage circuit. Aside from the simplicity, this setup has another advantage over traditional electro-spray nozzles in which parasitic attachment of some of the produced charged droplets to charging electrode typically occurs.

In practice, due to the complexity of electro-spraying dependent on many operating parameters, it can only be investigated experimentally because the proposed models cannot fully describe the behavior of working liquid. One of practically important spray characteristics is the distance from the liquid ejection point to the point at which the produced continuous liquid jet disintegrates into droplet spray, hereinafter referred as spraying distance. One of the electro-spraying stability issues, especially in case of directly electrified liquid, is that the spraying distance of a non-electrified jet can be significantly greater than that in case this jet is electrified, i.e. electro-spraying distance. In case when spraying distance is less than the distance from jet origin to collector electrode, the electrical short-cutting between the body of liquid and collector electrode may occur. Therefore, it is preferable that high-voltage should be applied to working liquid first before the spraying starts. This is to make sure that the disintegration of liquid jet starts at distance from the nozzle orifice, hereinafter referred as electro-spraying distance, before this jet reaches the collector electrode.

In practice, stable electro-spraying of directly charged pure water was successfully achieved at the voltage of +12 kV by a single nozzle with the diameter 0.2 mm elevated at about 40 cm from collector electrode and water flow rate of 0.28 mL/s. In this experimentally determined metrics as working example, electro-spraying distance was in the range of about 2-3 cm and stable droplet charging rate of about 2 μA was measured with Faraday cage, which gives the value of droplet charge to mass ratio of 7.14 mC/Kg. This value is of an order of magnitude higher than it was achieved with nozzle and a high voltage charging electrode configuration in the form of a ring centered around and located close to the exit point of the electrically grounded liquid from the feeding capillary with the same voltage, nozzle, and liquid flow, where the high voltage charging electrode had the diameter 30 mm and its plane was located at 5 mm distance from the nozzle orifice. The parts of high-voltage circuit including the body of electrically conductive liquid electrically coupled to HVDC source, diaphragm water pump, and parts of 12 VAC/12 VDC rectifier to feed the latter were effectively isolated from the mains with a traditional transformer, which ensured the safe and uninterrupted operation of test system.

An interesting experimental finding was that applying the air flow of about 1.4 m/s normal to the direction of liquid jet generated at the said parameters did not significantly affect the electro-spraying propagation and droplet collection at distances at least 20 cm from the ejection point of nozzle. This suggests that alternative configurations of the wet electro-scrubbing section of the proposed apparatus, where the directions of process air and jets of directly charged liquid are approximately orthogonal, i.e. in cross-flows, can be considered for the sake of simplicity, lower production costs, and easier scalability. One issue with simplified nozzles fed with electrified liquid is that their spraying performance depends on the distance from the origin of jet to droplet collector electrode. Therefore, the previously described base design with air-to-jets counter-flow and a possible design with air-to-jets co-flow, replacing ordinary nozzles with such nozzles would have a limitation on the length of electro-spraying flow, which could be relaxed only by increasing high-voltage and/or having more than one electro-spraying zones in series along the process air flow. These measures would bring additional complexity and costs and thus negate the potential advantages of the electro-spraying of charged liquid without charging electrodes.

In the cross-flows designs described above as non-limiting examples, a plurality of traditional electro-spraying nozzles with high-voltage charging electrodes can be replaced for example with 3D-printable structures or other manufacturing technologies, which is especially beneficial for the system scale up. Such a structure, hereinafter referred as electro-spraying electrode, serves as a container for the body of electrically conductive liquid at a high electric potential relative to the ground, preferably of positive polarity, and comprises a plurality of orifices for the liquid body, through which the liquid passes through with the aid of hydraulic pressure created with one or more pumps and forms multiple electro-spraying jets towards an grounded droplet collector electrode without using charging electrodes. It is preferred that the distance between orifices is not less than a certain (minimum) inter-jet distance. In a particular setup, this distance may depend on multiple parameters such as liquid flow rate, electrical potential, the distance from and shape of collector electrode etc. Based on experimental findings with the abovementioned parameters, it is recommended that the minimum inter-jet distance is about 100 mm, although it can be shorter distance at higher liquid flow rates and higher air flow volume.

In this invention, a multiple stage process along the process air, which combines a number of synergetic physical mechanisms, is proposed. In the first stage, aerosols in process air flow are negatively charged with emitter electrode of corona discharge 12. In the second stage, air ions and possibly a small fraction of charged aerosols are removed from the air by specially designed ion collector electrode 6. In this stage, practically all negative ions can be removed from process air, while most of charged aerosol particles continue to drift with this air. In the third stage, working liquid is atomized into small positively charged droplets (20-100 μm diameter is preferred) by electro-spraying electrode 16 and introduced in this form into process air, where the droplets can effectively scavenge weakly charged aerosol nano-particles such as viruses. It is preferred that working liquid is hygroscopic to prevent the droplet evaporation and maintain the relative humidity (RH) in a premise in the optimal range. In the preferred configuration, the direction of droplet ejection is across the stream of process air. In the fourth stage, droplets of the suspension of scavenged aerosols in working liquid are electrostatically collected. It is preferred that the electrostatic collector for liquid droplets is grounded droplet collector 8. The suspension accumulated on wetted grounded droplet collector 8 drips into gutter 24 and is then directed to collection tank 40 and from which the suspension is further directed to sedimentation tank 42, where the collected aerosols are sedimented. After the sedimentation, the purified working liquid can be re-used.

Evaporation of working liquid can be inhibited by using liquid desiccants that are typically aqueous hygroscopic salt solutions instead of water. Droplets of such solutions will not evaporate at the relative humidity (RH) of air equal to the equilibrium relative humidity (ERH) of salt solution. In the case of RH>ERH, the water vapor in air will condense on droplets and the solution droplets will evaporate in the opposite case. According to recent studies, maintaining RH in the optimal range is more important than previously thought. The airborne transmission of the SARS-CoV-2 via aerosol particles in indoor environment seems to be correlated with RH. An indoor relative humidity in the range of 40% to 60% cent could reduce the spread of this virus (Ahlawat et al., 2020). Although the additional benefit of this factor could be minor due to the removal of this pathogen particles, the safest RH range stated by authors is about the same as recommended for general health. The value of ERH of a particular salt solution or any other desiccant mostly depends on the chemical composition and concentration of a particular desiccant or a mixture of desiccants. In addition to air purification, electro-spraying of fine salt solution droplets can bring the benefit of RH stabilizing in premises within the optimal range.

Another benefit of salt solutions is that they are generally not favorable media for microbial pathogens. To achieve the recommended ERH of about 50%, the salt concentration should be high enough to inhibit or even permanently de-activate them. The information on this subject for different pathogens and different salts is still scarce at this stage of the art. Quan et al. (2017) reported the effectiveness of table salt (NaCl) in air filters in the inactivation of viruses. Seo et al. (2012) investigated the resistance of murine norovirus (MNV) and coliphage MS2, a culturable human norovirus surrogate, to temperature, salt, and pH. Both MNV and MS2 were rapidly inactivated at temperatures above 60° C. MNV demonstrated a high sensitivity to salt concentrations as low as 3.3 to 6.3% NaCl.

Although there is uncertainty about the de-activation time of different pathogens in different salt solutions at different concentrations, it is conservatively assumed to be within an hour, probably in conjunction with a moderate heating, before the solution can be re-used. Casual maintenance may be required to remove accumulated mud from sedimentation tank and keep the salt concentration within an optimal limit.

Even if the risk of leaking of uncollected droplets into the respiratory tract is very small, safety regulations in many countries require that the selected salt is not toxic. The ERH of non-toxic saturated magnesium chloride solution is about 33% which makes it a good candidate for this application. In practice, the waste sea brine from desalination plant, which is reach in Mg and Ca chlorides after removal or reducing of NaCl by industry standard processing is a cheaper alternative with the ERH of saturated solution of about 34%. The treated sea brine is natural and the degree of NaCl removal and concentration can be adjusted to the required ERH.

It is not necessary to limit ozone and nitrogen oxides production by corona discharge in ionization zone by safety standards, which limits corona discharge intensity in terms of ion production rate. This is because those gases in process air will quickly dissolve in droplets with high surface-to mass ratios. Ozone is a well-known efficient and rapid de-activator of micro-organisms, which will act together with salt solution as working liquid.

An Apparatus according to anyone of the preceding embodiments has a spraying zone 4 which further comprises at least one collector electrode 22 located in air flow direction in front of said air outlet 18. Further, at least one gutter 24 is provided for collecting said ejected droplets, collected by said grounded droplet collector 8. Finally, there is provided at least one stand 56 for supporting said apparatus.

### Aerosol Charging and Ozone Management

Along with aerosol capturing rate, the rate of ozone removal from air due to the diffusion into droplets is also determined by a particular design of electro-spray chamber. Generally, an increase in aerosol particle charges leads to an increase in aerosol capturing rate, but this increase is limited by maximum electric charge that a particle can achieve in ionization zone of a particular corona discharge device. In practice, however, a stricter limitation on aerosol charging may apply due to the ozone emission by corona discharge. Although a significant amount of ozone generated in ionization zone can be removed by electro-spray droplets, there could be a case when the ozone concentration in the processed air exiting the apparatus is higher than permitted in a particular application. This may happen because the rate of ozone diffusion in the spraying zone is insufficient to compensate the ozone emission in ionization zone at a given process air flow. One reason for this is that the liquid did not rest in sedimentation tank for a time sufficient for the ozone decay, which finally produces O₂. Using a larger sedimentation tank or two sedimentation tanks used alternately, i.e., one is in operation and other is resting, is recommended. Another reason is that in attempt to increase aerosol electro-scavenging rate by increasing aerosol charging, too high operating voltage of corona discharge was required. Since ion and ozone emissions, i.e., ionic current and mass per unit time respectively, are related in corona discharge, aerosol charging is limited by ozone emission in the ionization zone. At a given process air flow, increasing the volume of electro-spray zone by increasing the length of chamber leads to an increase of both aerosol and ozone removal rates. This allows a higher aerosol charging at a higher ionic current, which leads to a further increase in aerosol removal rate.

Additionally, or alternatively to enhancing electro-spray chamber, aerosol charging can be optimized in terms of minimizing the ozone emission at a given ionic current. The known approaches to reduce the ozone emission of corona discharge include selecting certain materials for emitting electrode, heating emitting electrode, and reducing operating voltage by increasing the sharpness of emitting electrode. However, limited materials and high sharpness may compromise the corrosion resistance and mechanical stability of emitter electrode; the heating can be used only as the last resort. In ionization-based chargers where diffusion mechanism of aerosol charging is dominant, the maximum electric charge that can be achieved on a particle is directly related to its size but the dependence on the ion concentration is weak (logarithm-like). In contrast, the particle charging time is inversely related to ion concentration. Therefore, it is a high ion concentration rather than ionic current, that may allow to achieve a short processing time of a volume of air in the ionization zone which, in addition to a lower ozone emission during this time, has another benefit of a smaller apparatus size, wherein the optimal length of aerosol charging chamber is the product of process air velocity and aerosol charging time.

At a given ionic current of corona discharge determined by operating voltage, the ion concentration is inversely related to electric field in the ion drift zone. The common problem with classic corona discharge embodiments is that the strength of this field is related to the electric field strength in a small area of ion production in the vicinity of emitter electrode surface, which should be sufficiently high above a certain inception value. In practice, this results in an excessively high electric field and an insufficient ion concentration in the drift zone, which means a poor ion utilization. For example, at the value of electric field of about 2 kV/cm in one version of demonstration apparatus, the ion velocity is about 20 m/s, which is about an order of magnitude higher than the velocity of air flow in this apparatus. Although the electrical component of charged aerosol velocity is significantly lower, this is not of interest in this case under consideration where the capture of aerosols on the collecting electrode of corona discharge is not required.

One solution to the problem is to achieve a reasonable ionic current of corona discharge at as lowest as possible values of operating voltage. This can be implemented with the aid of emitter electrode coating with a thin layer of some metal oxides such as Al₂O₃ or preferably TiO₂, which can enhance the ionization by Malter effect. Another benefit of such a coating is a reliable protection against corrosion, to which sharper electrodes are especially sensitive.

Another approach can be based on the de-coupling the ion emission and ion drift with the aid of one or more assisting electrodes for corona discharge, wherein the ion emission and drift are controlled by separate HVDCs. This method is successfully implemented in novel generators of ion wind (thrusters). The disadvantage of this approach is the complexity and higher cost of the multi-electrode system, which increases with the system scaling up by the partitioning of a large aerosol charging chamber, which will be discussed later. Moreover, both collecting and assisting electrodes require periodic cleaning or continuing washing which further complicates the design.

An interesting approach based on surface dielectric barrier discharge (SDBD) was proposed for ion thrusters in a number of configurations. In one simple design, metal plate is covered with a sheet of dielectric such as glass, plastic, or mica, which in turn is covered with a wire mesh. The plate and mesh are connected to a high voltage and high frequency source of AC or pulsed DC. In this simple device, cold plasma of bipolar ions is formed on dielectric surface close to mesh wires. If an external electrostatic field is applied, for example by means of the second metal plate parallel to the first one and at a potential relative to the mesh provided by a HVDC source, ions of a certain electric sign are extracted from plasma zone and drift in this field. Similar to the case of multi-electrode corona discharge, the ion production and drifting are de-coupled and driven with different power sources.

In a laboratory experiment conducted by the authors of this work, the following designs were tested as a non-limiting example. In a first design aiming to reproduce a work published online, a square sheet of mica was glued to metal plate with epoxy resin commonly used for the casting of electronic component, and the first sheet of fine wire mesh was placed on top of mica. AC voltage of 5 kV at 55 kHz from the first power source was applied between the plate and mesh. The negative electrode of the second (HVDC with variable voltage) power source was connected to the first mesh (i.e., of the SDBD) and the positive electrode to the second sheet of coarse mesh (0.4 mm wire with 10 mm spacing) fixed at the distance of 120 mm from SDBD and earthed. The second mesh did not produce corona discharge and used as an ion collecting electrode. The ionic current and AC consumption current were measured at different voltages of HVDC. A very encouraging result was that a significant pulsing current of negative ions was achieved at relatively low (a few kV) voltage of HVDC source. For the DC voltage values up to about 4 kV, both AC consumption current and ionic currents were increasing and the increase in ionic current was not linear, which suggests that the applied electrostatic field enhanced the plasma production. At higher values of this field, the AC current did not change and ionic current increased linearly with the voltage of HVDC source, which means that higher voltages no longer increase the plasma production in this configuration. This demonstrates the potential of SDBD to operate at low values of electric field for the ion drift, which can lead to a significant improvement of aerosol charging and thus the system performance in a more compact design.

The first improvement in terms of a higher ionic current was using pulsed DC instead of AC with the aid of a high voltage fast recovery diode 2CL20, which provided negative pulses to the plate. The second improvement was achieved by painting the sanded surface of mica with two coats of a specially formulated paint, which comprises well mixed epoxy resin and the powder of TiO₂, which is commonly used as white pigment in paints, in the mass ratio of 1:1. Metal mesh was gently pressed into partially hardened second coat with the aid of iron left until this coat hardens completely and the mesh is glued with it. A profound increase in the performance of this design is likely due to a high dielectric permittivity of TiO₂ and probably to the presence of Malter effect to some degree. It is preferable that the coating is made of TiO₂ using, for example, well established powder coating rather than a compound with a limited content of TiO₂.

Accordingly, the following simple design of aerosol charging chamber is proposed as a non-limiting example. A plurality of holes is made in the SDBD pate, wherein each hole preferably in square shape is located in the center of each square cell of the mesh where the plasma is not formed. Process air is supplied through this perforated structure, entering the chamber from the metal plate base. For the sake of easiness of safety, it is preferred that the metal plate base is earthed and positive HV pulses are applied to the mesh of SDBD, although the alternative configuration with the earthed mesh and negative HV pulses on the plate, which was originally used in the abovementioned experiments, is also possible. An electrode and HVDC source for ion extraction and drifting may not be needed because positive space charge of droplets and positively charged liquid produce a significant electric field for these purposes, and a high electric field of electrified water may even need to be reduced, for example, with a partial shielding using the earthed piece of a coarse metal mesh in the shape of disk, which is installed with the aid of a non-conductive support structure concentrically and at a safe distance from the closed end of the liquid supply pipe, wherein this end may also be supported by this structure. The required degree of electrical shielding can be adjusted by the spacing of mesh wire, which should be thick enough to prevent parasitic corona discharge with uncontrolled ozone emission. The distance between SDBD and the shielding disk should be the optimal for the timing of aerosol charging as previously described. In this approach, there will be some droplet charge loss in the beginning of electro-scavenging because the air is not de-ionized. However, the simplicity of this approach may outweigh a performance reduction over a certain part of the spraying chamber length, especially if the total length is large. It is preferred that the process air laden with charged aerosols enters closer to the enclosure of the spraying chamber and its propagation close to the chamber axis is minimized. This is because of the presence of a small dead zone where electro-spray jets are not disintegrated into droplets or not well developed yet. As a non-limiting example, the second flat or slightly conical disk made of a dielectric material can be installed additionally to the metal mesh disk or can be integrated with the latter. It is preferred that a similar approach to direct the process air away from the chamber axis is also used on the exit, this time in order to: (1) avoid the wetting of the support structure by droplets close to the pipe with electrified water (a small fraction of droplets is negatively charged and attracted to positively charged objects) and (2) to direct charged droplets by air flow toward the earthed inner wall of the enclosure, to which they are attracted rather than causing carryover with the exiting air.

### LIST OF REFERENCE SIGNS

2 ionization zone
4 spraying zone
6 ion collector electrode
8 grounded droplet collector
10 air inlet
12 emitter electrode of corona discharge
14 high-voltage direct current source having negative polarity
16 electro-spraying electrode
18 air outlet
20 high-voltage direct current source having positive polarity
22 collector electrode
24 gutter
26 liquid regeneration system
28 first pump
30 second pump
32 third pump
34 fourth pump
36 fifth pump
38 sixth pump
40 collection tank
42 sedimentation tank
44 storage tank
46 liquid reservoir
48 first valve
50 second valve
52 third valve
54 fourth valve
56 stand

1-15. (canceled)

16. Apparatus for electrostatic deactivation and removal of hazardous aerosols from air, said apparatus comprising
an ionization zone comprising at least one emitter electrode of corona discharge, configured to charge aerosols contained in a stream of supplied air and to obtain aerosols having negative air ions,
a spraying zone arranged above the ionization zone, comprising at least one electro-spraying electrode, configured to generate positively charged droplets and to absorb said charged aerosols by contacting them with said generated positively charged droplets,
a high-voltage circuit configured to provide directly charged liquid and comprising a high-voltage direct current source having positive polarity and a high-voltage direct current source having negative polarity, wherein the high-voltage direct current source having positive polarity is connected to the at least one electro-spraying electrode, and the high-voltage direct current source having negative polarity is connected to the at least one emitter electrode of corona discharge, and
a grounded circuit configured to provide electrically grounded liquid and comprising a collection device for collecting said negative air ions and said absorbed aerosols from said spraying zone,
wherein the apparatus is characterized in that
the collection device further comprises at least one grounded droplet collector, wherein the at least one grounded droplet collector is configured to accommodate the ionization zone and the spraying zone, so that the high-voltage circuit comprising the directly charged liquid is separated from the grounded circuit comprising the electrically grounded liquid during an operational sequence of the apparatus.

17. Apparatus according to claim 1, wherein said ionization zone further comprises at least one air inlet for guiding said stream of supplied air past said emitter electrode of corona discharge.

18. Apparatus according to claim 1, wherein said aerosols are charged in said ionization zone (2) in a time period of less than 1 second in air flow volumes starting from 50 cubic meters per hour m³/h.

19. Apparatus according to claim 1, wherein the at least one electro-spraying electrode is configured to eject droplets in at least one direction across said stream of supplied air.

20. Apparatus according to claim 1, wherein said spraying zone further comprises at least one air outlet.

21. Apparatus according to claim 1, wherein the at least one grounded droplet collector is configured to be in the form of two opposed walls or a surrounding cylinder.

22. Apparatus according to claim 1, wherein said collection device further comprises an ion collector electrode which is disposed between said ionization zone and said spraying zone.

23. Apparatus according to claim 2, wherein said air inlet) includes at least one suction fan.

24. Apparatus according to claim 2, wherein said air outlet includes at least one exhaust fan.

25. Apparatus according to claim 1, wherein said grounded droplet collector has a hydrophilic surface.

26. Apparatus according to claim 1, wherein said grounded droplet collector extends over spraying zone and ionization zone.

27. Apparatus according to claim 1, wherein said electro-spraying electrode has a shape of a perforated pipe, which is arranged parallel to said grounded droplet collector.

28. Apparatus according to claim 1, further comprising at least one liquid regeneration system having:
a first pump for pumping said absorbed aerosols to at least one collection tank;
a second pump for pumping liquid from said collection tank through a first valve to at least one sedimentation tank,
a third pump for pumping liquid from said sedimentation tank through a second valve to at least one storage tank,
a fourth pump for pumping liquid from said storage tank to said electro-spraying electrode,
a fifth pump for pumping liquid from at least one liquid reservoir through a third valve to said sedimentation tank, and
a sixth pump for pumping out sediments from said sedimentation tank through a fourth valve.
